(19) United States
(12) Patent Application Publication
(10) Pub. No.: US 2024/0072256 A1
(43) Pub. Date: Feb. 29, 2024

(54) WELL-DEFINED LEAD-ACID BATTERY ACTIVE MATERIALS

(71) Applicant: UCHICAGO ARGONNE, LLC, Chicago, IL (US)

(72) Inventors: Nigel BECKNELL, Glen Ellyn, IL (US); PIETRO PAPA LOPES, Woodridge, IL (US)

(21) Appl. No.: 17/895,840

(22) Filed: Aug. 25, 2022

(51) Int. Cl. H01M 4/58; C01G 21/20; H01M 4/38; H01M 4/56; H01M 4/62; H01M 4/73; H01M 10/08

(52) U.S. Cl. CPC H01M 4/5825; C01G 21/20; H01M 4/38; H01M 4/56; H01M 4/625; H01M 4/627; H01M 4/73; H01M 10/08; C01P 2002/60; C01P 2002/72; C01P 2002/82; C01P 2004/04; C01P 2006/40

(57) ABSTRACT

Described herein is crystalline PbSO₄ comprising tabular and/or diamond-shaped crystals having an average crystal size, as determined by dynamic light scattering and particle imaging using a transmission electron microscope, in the range of about 10 nm to about 2 μm, wherein at least about 80% of the PbSO₄ crystals have diameters within about ±20% of the average diameter. Also described herein electrodes, lead-acid electrochemical cells, and lead-acid batteries comprising the crystalline PbSO₄.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to lead-acid batteries. More particularly, this invention relates to lead-acid batteries comprising an electrode with crystalline lead sulfate of well-defined crystal size and habit in the initial discharged state of the electrode, as well as methods of making the crystalline lead sulfate.

### BACKGROUND OF THE INVENTION

Lead-acid battery manufacturing has two major problems that can be linked to the starting materials for electrode manufacture, and their processing steps.

First, the starting material for lead-acid battery manufacturing is leady oxide (a mixture of metallic lead and lead monoxide) sourced from Pb recovery from spent batteries. This leady oxide is converted into basic lead sulfate materials (xPbO·PbSO₄, such as tetrabasic lead sulfate, often described as 4PbO·PbSO₄) by reacting with sulfuric acid in the preparation of the paste that makes up current lead battery electrodes. This step, called electrode curing, requires control of both heating and moisture. Curing is highly energy-intensive and may take up to 2 days for completion. This also introduces unwanted variability in battery manufacturing, because of the difficulty in controlling the exact curing conditions.

Second, production of the Pb and PbO₂ active materials requires a final formation process, which is the most energy-intensive step during battery manufacturing (6-8 times the energy actually stored in a battery). To date, there have been no attempts to solve these problems by using a well-defined starting material that can be converted to Pb and PbO₂ efficiently using less energy and time and improving reliability.

The materials and methods described herein address these ongoing problems in lead-acid battery manufacture.

### SUMMARY OF THE INVENTION

Described herein is a well-defined PbSO₄ material with controlled crystal size and shape for use as an initial electrode active material in discharged lead-acid batteries. A method of preparing the size- and shape-controlled PbSO₄ is also described. This material comprises nano- to micro-sized PbSO₄ crystals that demonstrate an ability to control the rate of the active electrode formation step with essentially 100% conversion efficiency. In the electrodes and batteries described herein, the starting battery material remains in a Pb(2+) state, which leads to potentially simpler, less energy-intensive battery recycling strategies. Because the starting battery material is already sulfated, the typical curing process is eliminated altogether. The electrodes and batteries described herein also do not require any other chemical reactions to occur during electrolyte fill or prior to the formation step. Finally, controlling the size and shape of the lead sulfate crystals enables control of the efficiency and rate at which the material charges in the battery. This reduces the energy required for electrode formation (i.e., reduction of Pb(2+) to Pb(0)) to a level that is equal to the amount of energy stored in the battery, creating a far more time and energy-efficient formation step.

An electrode for a lead-acid battery, as described herein, comprises, in its initial, discharged state, crystalline PbSO₄ having a selected average particle size, as determined by dynamic light scattering and particle imaging using a transmission electron microscope, of about 10 nm to about 2 μm (e.g., about 20 nm to about 2 μm; or about 50 nm to about 1.5 μm), with a particle size distribution in which at least about 90% of the crystals have a particle size within about 20% of the average. The crystals also have a well-defined crystal habit comprising rectangular slabs and/or diamond-shaped crystals.

In some preferred embodiments, the crystalline lead sulfate is combined with particulate carbon, such as carbon black, graphite, free-standing graphene, graphene oxide, reduced graphene oxide, single-walled and multi-walled carbon nanotubes, and the like. The crystalline lead sulfate and carbon, when present, are applied as a paste to a pasted plate grid-type, or tubular-type metallic frame to form the initial electrode structure. Typically, the pasted plate and tubular electrode frames are constructed from a hardened lead alloy (e.g., Pb alloyed with Sb, Ca, Se, and/or Sn). The active material paste fills voids in the grid or tubular structure, while the conductive frame provides a path for current flow throughout the plate. The active electrode is then formed in situ in an assembled battery after filling the battery with sulfuric acid electrolyte. Active electrode formation is accomplished by charging the initial electrode to convert a selected portion of the Pb(2+) to Pb(0) or in its entirety. Typically this can be achieved by passing a current equivalent to the amount of electricity contained in the electrodes over a predetermined amount of time, from 30 minutes to 10 hours, then afterwards holding the cell voltage at a maximum voltage value, for example but not limited to, 2.5V until the current decreases to a steady state value.

Typically, the crystalline PbSO₄ is mixed with a particulate carbon material and binder to form a paste, which is then loaded onto a pasted plate grid or tubular electrode frame, followed by drying to form the initial electrode in a fully discharged state. Other optional components of the paste include, but not limited to, solid expander additives such as lignosulfonate powder and the like, baryte group inorganic crystals (e.g., BaSO₄, CaSO₄, SrSO₄, and mixtures thereof), polymer fibers, and glass fibers.

A method of preparing size-and shape-defined crystalline lead sulfate comprises gradually mixing equimolar amounts of Pb(2+)-containing and SO₄(2−)-containing precursor solutions into an acidic crystal-growth control solution comprising a crystal-growth modifier (CGM; e.g., a linear or branched polyimine, for example, poly(ethyleneimine) (PEI) and the like) and acetic acid at a pH in the range of about 1 to about 5, at a defined rate of addition in the range of about 0.01 micromoles to 1000 millimoles of Pb(2+) and SO₄(2−) per minute. Preferably, the crystal-growth modifier is present in the control solution at a concentration in the range of about 0.01 to 50 g/L, and the volume of control solution is about 0.1 to about 10 times the total volume of Pb(2+) and SO₄(2−) being added. The crystals can also be allowed to grow for a selected period of time in the range of about 0.01 to about 5000 minutes, before the crystals are isolated and washed with water to remove the crystal-growth modifier and soluble salt contaminants. The Pb(2+)-containing precursor solution and the SO₄(2−)-containing precursor solution typically have concentrations in the range of about 0.001 to about 1M.

The crystal habit can be affected by the ratio of Pb to CGM. For Example, when the CGM is PEI, predominately tabular crystals are formed when the ratio of Pb to PEI is about 6 mmol Pb²⁺ per gram PEI or less, while predominately diamond-shaped crystals are formed when the ratio of Pb to PEI is about 11 mmol Pb²⁺ per gram PEI or more Between about 6 to 11 mmol Pb²⁺ per gram PEI is a transition between the crystal habits.

In an electrochemical cell, the counter electrode typically is a lead flat plate electrode, and the electrodes are immersed in an electrolyte comprising about 1 to about 5 M aqueous sulfuric acid, with a porous membrane between the PbSO₄ and counter electrodes. In some other embodiments, the counter electrode can comprise PbO₂, or a mixture of Pb and PbO₂. In some other embodiments, the cell can comprise two of the electrodes comprising the crystalline PbSO₄ described herein, polarized to form Pb and PbO₂ in situ.

The following non-limiting embodiments are provided below to illustrate certain aspects and features of the electrochemical cells and batteries described herein.

Embodiment 1 is an electrode for a lead-acid battery comprising, in an initial, discharged state, a paste of tabular and/or diamond-shaped PbSO₄ crystals in a conductive metal grid framework; wherein the crystals have a selected average crystal size, as determined by dynamic light scattering and particle imaging using a transmission electron microscope, of about 10 nm to about 2 μm, with a particle size distribution in which at least about 90% of the crystals have a particle size within about 20% of the average diameter.

Embodiment 2 is the electrode of embodiment 1, wherein the paste further comprises a particulate carbon material.

Embodiment 3 is the electrode of embodiment 2, wherein the particulate carbon material comprises at least one material selected from the group consisting of carbon black, graphite, free-standing graphene, graphene oxide, reduced graphene oxide, single-walled carbon nanotubes, and multi-walled carbon nanotubes.

Embodiment 4 is the electrode of any one of embodiments 1 to 3, wherein the paste further comprises solid expander additives, baryte group inorganic crystals (e.g., BaSO₄, CaSO₄, SrSO₄, and mixtures thereof), polymeric fibers, and glass fibers.

Embodiment 5 is the electrode of any one of embodiments 1 to 4, wherein the PbSO₄ crystals have an average particle size in the range of about 140 nm to about 160 nm.

Embodiment 6 is the electrode of any one of embodiments 1 to 4, wherein the PbSO₄ crystals have an average particle size in the range of about 180 nm to about 220 nm.

Embodiment 7 is the electrode of any one of embodiments 1 to 4, wherein the PbSO₄ crystals have an average particle size in the range of about 250 nm to about 290 nm.

Embodiment 8 is the electrode of any one of embodiments 1 to 4, wherein the PbSO₄ crystals have an average particle size in the range of about 1 μm to about 1.4 μm.

Embodiment 9 is the electrode of any one of embodiments 1 to 8, wherein the metal grid framework is composed of a hardened lead alloy.

Embodiment 10 is a lead-acid electrochemical cell comprising the electrode of any one of embodiments 1 to 9 and a counter electrode with a proton-conductive separator therebetween, wherein the electrode, counter electrode, and separator are immersed in an electrolyte comprising aqueous sulfuric acid.

Embodiment 11 is the electrochemical cell of embodiment 10, wherein the counter electrode comprises at least one material selected from the group consisting of metallic lead, PbO₂, and crystalline PbSO₄.

Embodiment 12 is the electrochemical cell of embodiment 10 or 11, wherein the sulfuric acid has a concentration in the range of about 1 to about 5 M.

Embodiment 13 is the electrochemical cell of any one of embodiments 10 to 12, wherein the cell has been electrochemically cycled within a voltage window of about −1.35 V to −0.85 V versus Hg/Hg₂SO₄ reference electrode to convert at least a portion of the PbSO₄ to Pb(0) and achieve a state of charge in the range of about 50 to about 100%, thereby forming an active, charged electrode.

Embodiment 14 is a lead-acid battery comprising two or more of the electrochemical cells of any one of embodiments 1 to 13 electrically connected in series, in parallel, or in both series and parallel.

Embodiment 15 is a method of preparing PbSO₄ crystals with a tabular and/or diamond crystal shape and a selected average crystal size; the method comprising:
mixing equimolar amounts of a Pb(2+)-containing precursor solution and a SO₄(2−)-containing precursor solution into an acidic crystal-growth control solution comprising a crystal-growth modifier (e.g., a polyimine such as poly(ethyleneimine) (PEI)) and acetic acid at a pH in the range of about 1 to 5, at a defined rate of addition in the range of 0.01 micromoles to 1000 millimoles of Pb(2+) and SO₄(2−) per minute, thereby forming tabular and/or diamond-shaped PbSO₄ crystals that have an average crystal size, as determined by dynamic light scattering and particle imaging using a transmission electron microscope, of about 10 nm to about 2 μm (e.g., about 20 nm to about 2 μm; or about 50 nm to about 1.5 μm), with a particle size distribution in which at least about 90% of the crystals have a particle size within about 20% of the average diameter;
washing the crystals with water to remove the crystal-growth modifier and soluble salt contaminants; and
recovering the crystals.

Embodiment 16 is the method of embodiment 15, wherein the crystal-growth modifier is present in the control solution at a concentration in the range of 0.01 to 50 g/L, and the volume of the crystal-growth control solution is about 0.1 to about 10 times the total volume of Pb(2+) and SO4(2−) being added.

Embodiment 17 is the method of embodiment 15, wherein the Pb(2+)-containing precursor solution and the SO₄(2−) containing precursor solution have concentrations in the range of about 0.001 to about 1M.

Embodiment 18 is the method of any one of embodiments 15 to 17, wherein the crystals are allowed to grow for a selected period of time in the range of about 0.1 to about 5000 minutes, before the crystals are isolated and washed with water to remove the crystal-growth modifier and soluble salt contaminants.

Embodiment 19 is crystalline PbSO₄ comprising tabular and/or diamond-shaped crystals having an average crystal size, as determined by dynamic light scattering and particle imaging using a transmission electron microscope, of about 10 nm to about 2 μm, with a particle size distribution in which at least about 90% of the crystals have a particle size within about 20% of the average diameter.

Embodiment 20 is the crystalline PbSO₄ of embodiment 18, wherein the crystals have an average diameter selected from the group consisting of (a) about 140 nm to about 160 nm; (b) about 180 nm to about 220 nm; (c) about 250 nm to about 290 nm; and (d) about 1 μm to about 1.4 μm.

The crystalline PbSO₄ materials described herein provide significant advantages when used to form active electrode materials for use in lead-acid cells and batteries. In particular, the crystalline PbSO₄ materials provide advantages such as, e.g., the starting battery material remains in a Pb(2+) state, which leads to potentially simpler, less energy-intensive battery recycling strategies; the typical electrode curing process is eliminated; the electrodes and batteries do not require any other chemical reactions to occur during electrolyte fill or prior to the formation step; and controlling the size and shape of the lead sulfate crystals enables control of the efficiency and rate at which the material charges in the battery. This reduces the energy required for electrode formation to a level that is equal to the amount of energy stored in the battery, creating a far more time and energy-efficient formation step.

### BRIEF DESCRIPTION OF THE DRAWINGS

FIG. 1 provides (a) transmission electron microscopy (TEM) images of PbSO₄ crystals formed by the methods described herein; (b) a schematic illustration of control of crystal size by injection time and growth time; (c) PbSO₄ particle size histograms obtained from TEM and dynamic light scattering (DLS); (d) PbSO₄ crystal characterization by Raman and x-ray diffraction (XRD) spectroscopy; (e) TEM images of PbSO₄ crystals with carbon; and (f) PbSO₄ crystal stability in water.

FIG. 2 provides (a) results of window-opening experiments to set potential windows; (b) scan rate dependence of cyclic voltammograms (CV) of lead sulfate with 10 or 20 wt % VXC72 carbon; (c) charge and discharge capacities at different scan rates; (d) charge peak development on 2^{nd} and 3^{rd} cycles; and (e) a comparison of the amount of expected loading capacity utilized at various charge rates.

FIG. 3 illustrates electrochemical testing of PbSO₄ crystals at different SoC levels (25, 50 and 75%).

FIG. 4 illustrates the effect of crystal size on (a) first cycle charge; (b) hold; (c) first discharge; (d) capacities of charge and discharge on first cycle; (e) second charge; and (f) Kinetic Charge Acceptance (KCA) metric defined as the charge current normalized by the discharge capacity.

FIG. 5 schematically illustrates an electrode comprising the well-defined lead sulfate crystals described herein.

FIG. 6 schematically illustrates an electrochemical cell comprising the electrodes described herein.

FIG. 7 schematically illustrates a lead-acid battery.

### DETAILED DESCRIPTION

As described herein, PbSO₄ crystals with a well-defined crystal size distribution are prepared by a controlled precipitation method using slow injection of soluble Pb²⁺ and SO₄²⁻ precursors. The method utilizes a crystal-growth modifier (CGM), such as polyethylenimine (PEI), to control the nucleation and growth of PbSO₄ in an aqueous solution acidified with acetic acid. Without the CGM, PbSO₄ precipitates immediately in an uncontrolled manner, leading to micron-sized particles that are non-uniform in shape. The CGM serves to slow the kinetics of nucleation and growth so that PbSO₄ particles with narrow size distribution can be synthesized.

Suitable crystal-growth modifiers include, for example, linear or branched cationic polymers such as polyimines (e.g., poly(ethyleneimine) (PEI), poly(propyleneimine), poly(ethyleneimine-co-propyleneimine), and the like), polymers comprising charged quaternary amino groups (e.g., poly(diallyldimethylammonium chloride), PDDAC); linear or branched non-polymeric amines (e.g., ethylamine, propylamine, hexadecylamine, tert-butylamine, ethylenediamine, propylenediamine, tris(aminomethyl)methane, and the like), and water soluble polymers such as polyethyene glycol, polyacrylamide, polyacrylic acid, polyvinylalcohol, polyvinylpyrrolidone, carboxymethylcellulose, and the like.

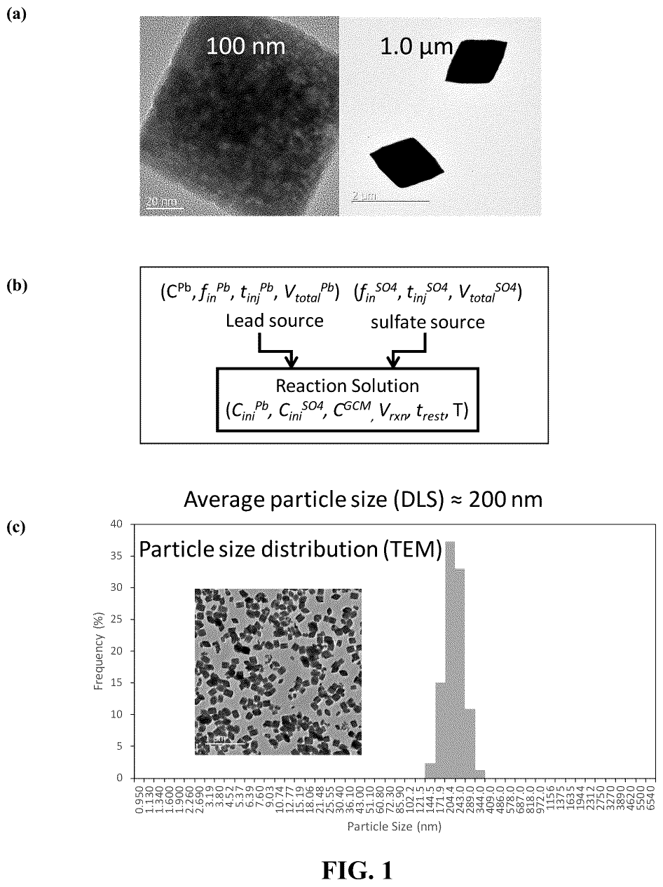

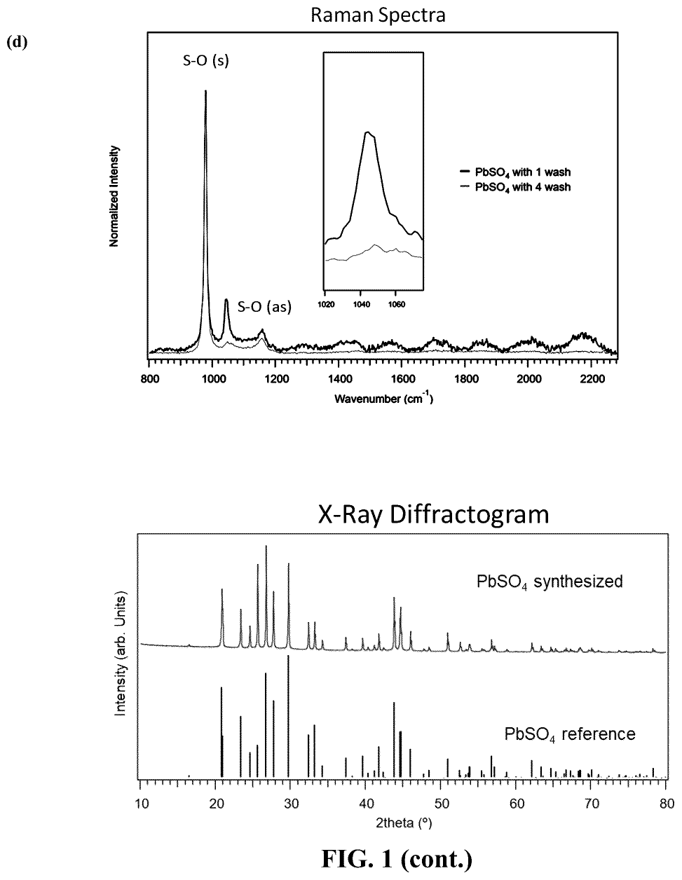

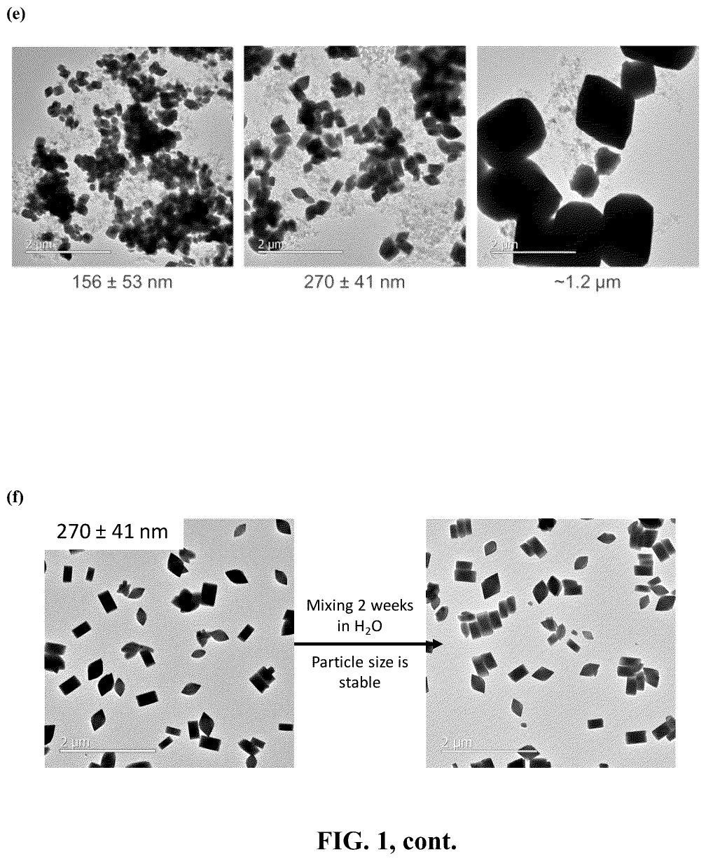

The sizes of the PbSO₄ crystals were controlled by varying either the injection time of the Pb²⁺ and SO₄²⁻ precursors, or the growth time, defined as the length of time in the reactor after precursor injection is ceased. Due to the comparatively high solubility of PbSO₄ in the reaction solution, the particles continue to grow by Ostwald ripening if left in the reactor indefinitely. Once washed and dispersed in pure water, the PbSO₄ crystals exhibit excellent stability in their size and shape. As examples, lead sulfate of four particle sizes (156 nm, 200 nm, 270 nm, and 1.2 μm) were synthesized and studied electrochemically. The 200 nm particles were made at the faster injection rate compared to the other sizes, creating more or less a mixture of the two crystal habits (diamond-shaped and rectangular slabs), whereas the other crystals exhibited predominantly one major crystal habit. The samples were characterized with X-ray diffraction and Raman spectroscopy to confirm that they were pure PbSO₄ phase and that the reaction chemicals had been sufficiently washed away. Finally, the particles were mixed with VULCAN XC-72 carbon black in a mass ratio of 80:20 or 90:10 PbSO₄:C for electrochemical evaluation. The carbon provides conductivity for enhancing the electrochemical reactions of the PbSO₄ crystals. FIG. 1 shows (a) transmission electron microscopy (TEM) images of PbSO₄ crystals formed by the methods described herein; (b) a schematic illustration of control of crystal size by injection time and growth time; (c) PbSO₄ particle size histograms obtained from TEM and dynamic light scattering (DLS); (d) PbSO₄ crystal characterization by Raman and x-ray diffraction (XRD) spectroscopy; (e) TEM images of PbSO₄ crystals with carbon; and (f) PbSO₄ crystal stability in water.

Electrochemical studies of these particles were performed by dropcasting the PbSO₄/carbon composite onto glassy carbon electrodes. PbSO₄ particle cycling was studied as a function of potential window and scan rate to establish the approximate potentials and rates at which these particles were electrochemically active. During charging, lead(II) ion from the PbSO₄ is reduced to Pb(0). In the discharge phase of cycling, Pb(0) is oxidized back to Pb(2+). All experiments were performed in 5 M H₂SO₄ under Ar purging with a Hg/Hg₂SO₄ reference electrode, and all potentials are given relative to the Hg/Hg₂SO₄ reference potential. The PbSO₄ particles demonstrated a clearly defined onset potential for charging at approximately −1.12 V. As the negative potential limit was expanded from −1.25 to −1.35 V, additional charging of the PbSO₄ occurred. The potential window was standardized to be −0.85 to −1.35 V, where the positive limit was chosen to ensure full discharge and the negative limit to avoid catalyzing hydrogen evolution.

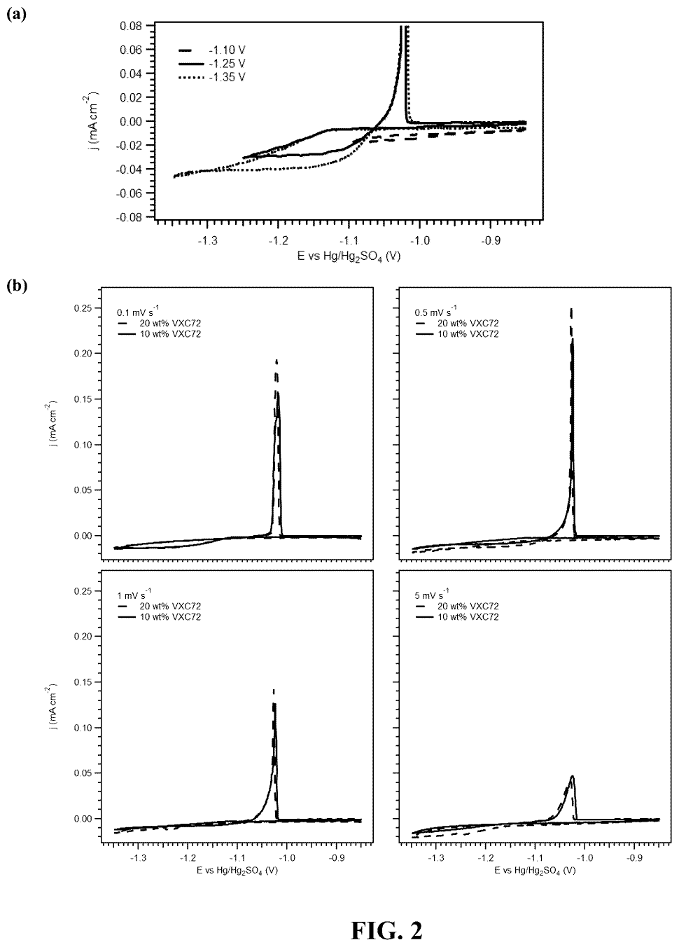

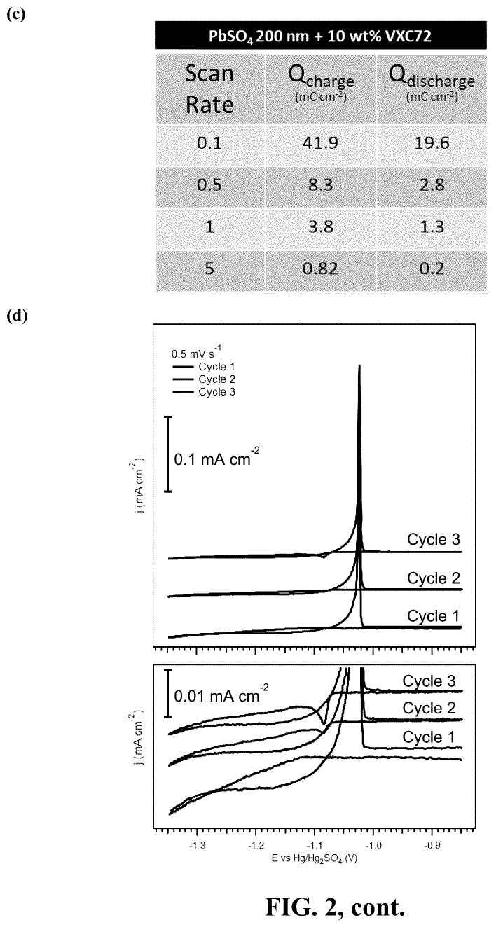

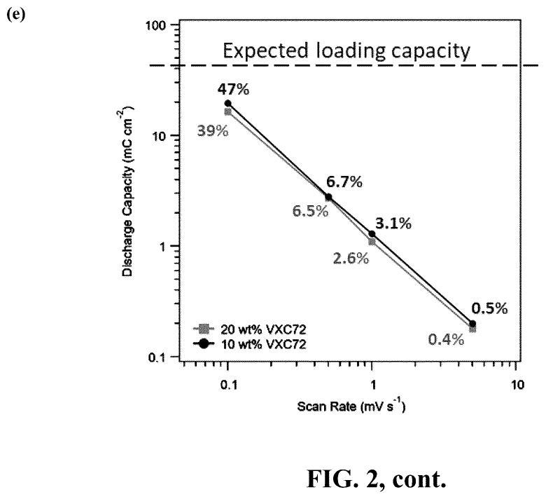

A single cyclic voltammogram (CV) of these particles at scan rates ranging from 5 to 0.1 mV/s provided understanding of the charging kinetics of pure 200 nm PbSO₄ crystals. FIG. 2 provides (a) results of window-opening experiments to set potential windows; (b) scan rate dependence of cyclic voltammograms (CV) of lead sulfate with 10 or 20 wt % VXC72 carbon; (c) charge and discharge capacities at different scan rates; (d) charge peak development on 2^{nd} and 3^{rd} cycles; and (e) a comparison of the amount of expected loading capacity utilized at various charge rates. As the scan rate was decreased, the charge capacity of PbSO₄ increased due to a better match between charging rate and the PbSO₄ dissolution rate. At 0.1 mV/s, it was even possible to obtain a near perfect agreement between the expected loading capacity of PbSO₄ (41.5 mC/cm²) on the glassy carbon electrode and the measured charging capacity (41.9 mC/cm²), indicating the ideal time and potential needed to fully charge this electrode. The Coulombic efficiency during the first cycle improved from about 24% at 5 mV/s to about 47% at 0.1 mV/s. The scan rate dependence of discharge from Pb to PbSO₄ is due to the well-known Peukert effect, which has also been studied on polished Plante Pb disks. As the scan rate decreases, thicker PbSO₄ films grow before full passivation, explaining the improved Coulombic efficiency of the PbSO₄ particles at 0.1 mV/s.

Single cyclic voltammograms on polished Plante Pb disks also indicate that after forming a PbSO₄ film on discharge, the charging scan has a well-defined peak around −1.07 V. When charging PbSO₄ particles for the first time, a charging peak is not observed, even at slow scan rates such as 0.1 mV/s. However, if cycled a second time at a scan rate of 0.5 mV/s or slower, the charging peak begins to develop, and the peak grows in size on the third cycle. Because of the scan rate dependence of the formation of the charging peak, the peak's presence appears linked to the charge and discharge capacities of the first cycle. In other words, the peak only appears if the electrode exists at a certain state-of-charge (SoC) before the start of the second cycle. Because the charging peak barely develops on the second cycle at 0.5 mV/s, the charge and discharge capacities from the first cycle at 0.5 mV/s were used to determine that the minimum SoC for 200 nm particles to develop a charging peak is about 13% with an 80:20 mass ratio of PbSO₄:C. Therefore, this charging peak is indicative of a sufficient Pb/PbSO₄ interface that accepts charge through deposition of Pb²⁺ onto Pb at a lower overpotential than the pure PbSO₄ electrode. This finding aligns well with the standard use of lead-acid batteries at high or partial SoC and their failure during deep discharge due to sulfation.

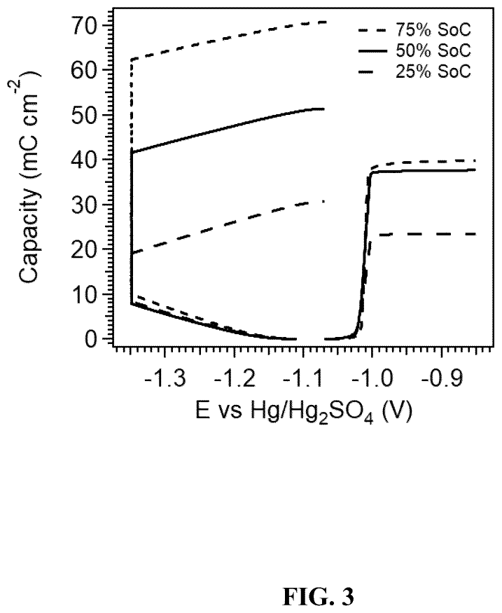

Given that the SoC was determined to be important to the cycling behavior of the PbSO₄ crystals, we established a cycling protocol that enables control over SoC under potentiostatic conditions within the first cycle. FIG. 3 illustrates electrochemical testing of PbSO₄ crystals at different SoC levels (25, 50 and 75%). The PbSO₄/C electrode was immersed in 5 M sulfuric acid at −0.85 V and a linear sweep voltammogram was performed to −1.35 V at 1 mV/s. This step provides some charging of the particles, but does not exhibit a charging peak, since the electrode starts with pure PbSO₄ (0% SoC). The charge capacity, labeled Q₁, was calculated from the linear sweep voltammogram between −1.11 V (the onset potential for pure PbSO₄ reduction) and −1.35 V. Next, the potential was held at −1.35 V until the total charge from the potentiostatic condition, Q₂, and Q₁ provided the desired SoC. The desired SoC was calculated as shown in Equation 1:

$$Desired SoC = \frac{{Q}_{1} + {Q}_{2}}{loaded capacity}$$

Finally, a discharge scan from −1.35 V to −0.85 V was performed, followed by a second charge scan back to −1.35 V.

The control over the SoC provides further insight into the PbSO₄ reduction at the charging peak (approximately −1.07 V) versus PbSO₄ reduction at higher overpotential (below −1.12 V). At a condition of 25% SoC, the electrode is relatively starved of Pb surface during discharge, resulting in a smaller discharge capacity than at 50% or 75% SoC. Interestingly, the discharge capacity is relatively equal after charging to either 50% or 75% SoC, but the discharge current is higher in the 75% SoC electrode. The equivalence in discharge capacity is indicative of the Peukert effect, which limits the discharge capacity because the discharge rate (scan rate) is the same. The 75% SoC demonstrates a slightly higher discharge capacity due to the larger Pb surface area generated during charge, while it demonstrates significantly higher discharge current due to the decreased resistance within the electrode layer from increased formation of metallic Pb.

During the second charge scan, the charging capacity and current at −1.07 V increases with increasing first cycle SoC. The higher SoC exhibits a larger Pb/PbSO₄ interface, accelerating charge kinetics in the low overpotential region. At higher overpotential, the current plateaus in all cases. The plateau current is equivalent for the 25% and 50% SoC due to significant amounts of remaining bulk PbSO₄ that are kinetically limited by the dissolution rate, while the 75% SoC has a smaller plateau current, because it has less bulk PbSO₄ remaining. Ultimately, all three electrodes attain similar charging capacity in the second charge, although by different mechanisms of charging at the Pb/PbSO₄ interface versus bulk PbSO₄.

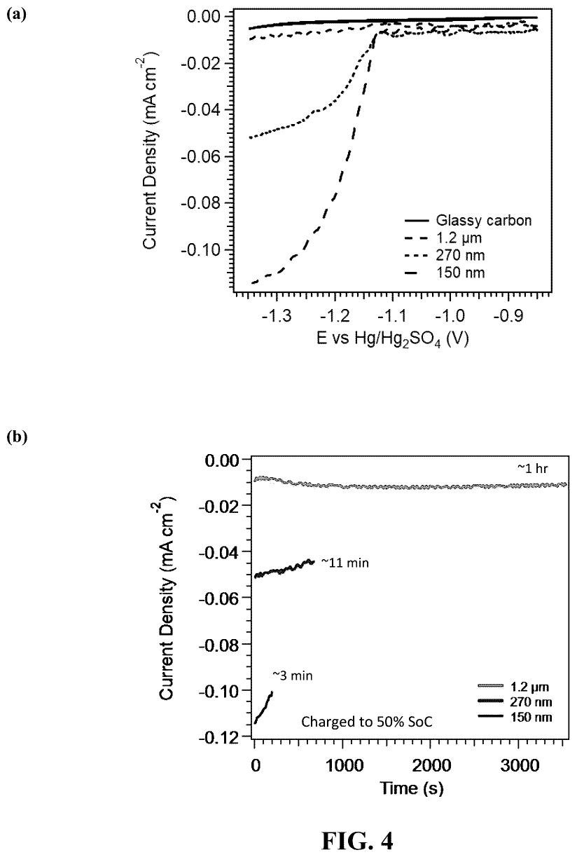

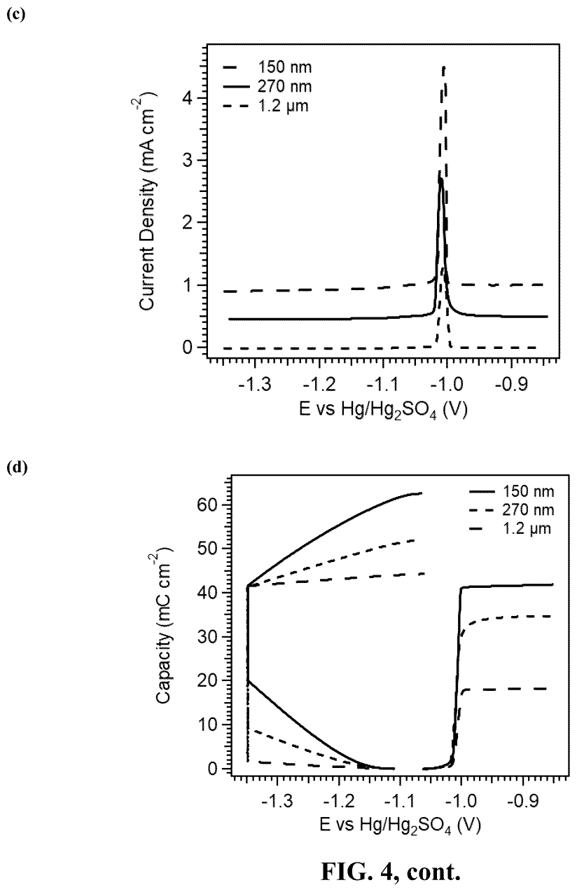

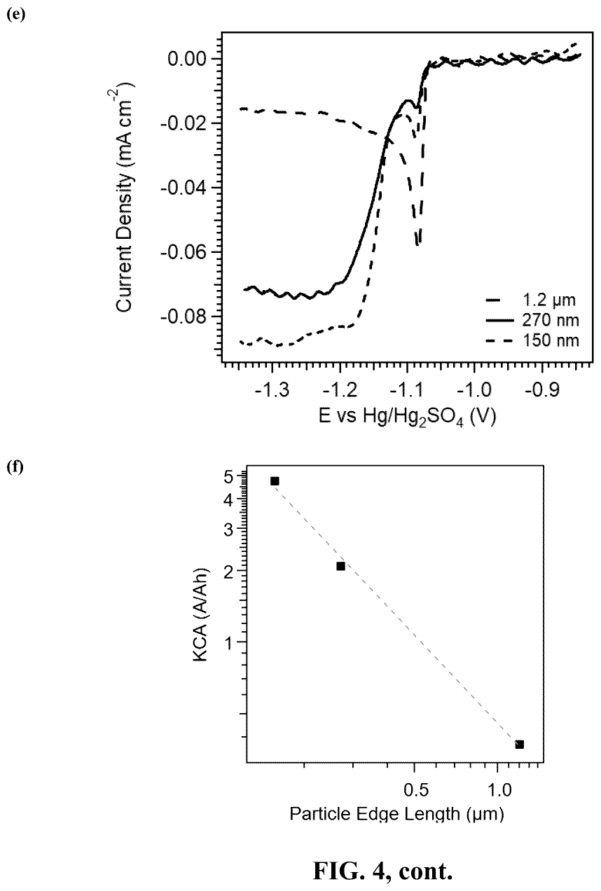

The comprehensive understanding of the kinetics and mechanisms of charging well-defined PbSO₄ particles establishes the background knowledge needed to study the impact of PbSO₄ particle size on lead-acid electrochemistry. FIG. 4 illustrates the effect of crystal size on (a) first cycle charge; (b) hold; (c) first discharge; (d) capacities of charge and discharge on first cycle; (e) second charge; and (f) KCA. The protocol discussed above was used to cycle 156 nm, 270 nm, and 1.2 μm crystals with 20 wt % VULCAN XC-72 carbon black, establishing 50% SoC after the first charge. As noted previously, a distinct onset potential for charging is observed at approximately −1.12 to −1.13 V during the first charging scan. During this first linear sweep, the 156 nm particles demonstrate significantly higher charging currents, leading to over twice and 10 times the capacity of the 270 nm and 1.2 μm particles, respectively. This is a significant achievement demonstrating that pure PbSO₄ can be charged quite efficiently below a certain crystal size. Each electrode was then charged to 50% SoC at −1.35 V. During this potential hold, the 156 nm particles charged at approximately two and 10 times faster rate than the 270 nm and 1.2 μm particles, respectively, resulting in a proportional improvement in the charging time to 50% SoC. Additional charging occurred during the following positive linear sweep to −0.85 V. Before discharge commenced, the 156 nm particles reached 76% SoC, while the 270 nm and 1.2 μm particles reached 62% and 53% SoC, respectively.

On discharge, the current and capacity were highest for the 156 nm particles due to the higher surface area for Pb discharge and the less resistive electrode with higher Pb content. As discussed previously, the Peukert effect limits the discharge capacity. In the previous example (FIG. 3), different SoC levels for an identical particle size (270 nm) were compared. Both the 75% and 50% SoC electrodes attained a discharge capacity of about 38-40 mC/cm², which was limited due to the Peukert effect. Therefore, the Coulombic efficiency for the 75% SoC electrode (56%) was much lower than the 50% SoC electrode (73%), because the electrodes have identical particle surface area leading to underutilized Pb in the 75% SoC electrode. In comparing particle size, different surface areas are compared with a goal of identical SoC, although the true SoC ends up significantly different. It is interesting that the Coulombic efficiency for discharge is nearly identical between the 156 nm and 270 nm particles (70-72%), while the 1.2 μm particles are significantly lower (42%). While the higher surface area enables the 156 nm particles to deliver higher discharge capacity (44 mC/cm²) than the 270 nm particles (37 mC/cm²), the overall Coulombic efficiency is still limited by the Peukert effect, wasting Pb that was formed in the 156 nm particles which achieved a 76% SoC.

Finally, the second charge for each particle size provides interesting insight into the charging mechanisms. The SoC levels at the beginning of the second charge scan are 23%, 18%, and 31% for 156 nm, 270 nm, and 1.2 μm particles, respectively. The 1.2 μm particles maintain such a high SoC because their discharge performance was so poor. This causes the charging peak on the second charge scan to be much larger for the 1.2 μm particles. The 150 nm particles have the next largest charging peak due to their next highest SoC, followed by the 270 nm particles with the smallest charging peak due to their smallest SoC. The 1.2 μm particles have a large Pb/PbSO₄ interface for charging at low overpotential, but at higher overpotential, they still demonstrate less charging of bulk PbSO₄. As expected, the 156 nm particles exhibit the best charging of bulk PbSO₄ at high overpotential and the highest charging capacity overall on the second charge.

To quantify the overall impact of the particle size on the charging performance of the PbSO₄ material, a Kinetic Charge Acceptance (KCA) parameter was defined as shown in Equation 2:

$$K C A = \frac{Average charging current at - 1.35 V}{Expected loading capacity}$$

The KCA demonstrates the overall impact of the particle size on the rate and capacity of charging. The KCA parameter demonstrates that the 156 nm PbSO₄ particles improve charging performance by a factor of over two and over 10 times compared to the 270 nm and 1.2 μm particles.

In some preferred embodiments, the cathode comprises a particulate carbon material. Preferably the particulate carbon material comprises carbon nanoparticles or microparticles. As used herein, the term “nanoparticle” refers to particles in the range of about 1 up to about 900 nanometers (nm) in average size. As used herein, the term “microparticle” refers to particles in the range of greater than 900 nm to about 10 micrometers (μm) in average size. Nonlimiting examples of suitable carbon materials include, e.g., carbon nanotubes (e.g., single-walled carbon nanotubes, multi-walled carbon nanotubes, and the like), carbon nanofibers, graphene, graphene oxide, reduced graphene oxide, carbon black, and graphite. The term nanotube refers to tubular carbon materials with a tubular diameter in the range of about 0.4 to about 100 nm, which can have lengths of 1 nm to 1 micrometer, or more. Single-walled carbon nanotubes typically have a tubular wall that has a thickness of a single carbon atom, while multi-walled nanotubes have tubular walls with several nested layers of carbon. The term nanofiber refers to fibrous carbon materials with a fiber diameter in the range of about 50 to about 200 nm, which typically can have lengths of about 1 to 200 micrometers. Preferably, the particulate carbon material is mixed with the lead sulfate crystals in a past that is coated or packed onto pasted plate grid or a tubular plate electrode framework to form the electrode in its initial discharged state. The mass ratio of lead sulfate to carbon can be from about 99.9:0.1 to about 50:50 (e.g., about 80:20 or 90:10). The lead sulfate/carbon mixture is combined with at least one protic solvent such as water or an alcohol (e.g., methanol, isopropanol, and the like) to form a suspension with a solids concentration in the range of about 1 mg/L to about 100 g/L (based on mass of solids in volume of solvent) constituting the paste. The pasted plate or tubular framework acts as a current collector for the electrode.

The counter electrode for the lead-acid electrochemical cell typically comprises a hardened metallic lead alloy. For example, the counter electrode can be a rod or bar, a sheet, a foil, or a foam of metallic lead or an alloy thereof.

In each electrochemical cell, the electrolyte contacts both electrodes and comprises an aqueous solution of sulfuric acid. Typically, the sulfuric acid is present in the electrolyte solution at a concentration of about 1 to about 5 M. In some embodiments, the sulfuric acid solution is about 5 M.

Each cell also includes a separator membrane between the electrodes. The separator is a proton-permeable or conducting membrane or film that allows hydrogen ions to pass through the membrane or film to balance the electrical charges formed at the electrodes during charging and discharging of the cell, while preventing passage of zinc ions to the cathode. The separator can be any ion-conductive material. Non-limiting examples of such materials include, e.g., a fluorinated ionomer (such as a NAFION sulfonated tetrafluoroethylene based fluoropolymer-copolymer), a sulfonated polyether ether ketone (S-PEEK), a polybenzirnidazole (PBI) membrane doped with a strong mineral acid, an interpenetrating network of polybenzimidazole (PBI) and polyvinylphosphonic acid, a proton-conducting ceramic film (e.g., barium zirconates (BaZrO₃) or cerates (BaCeO₃) doped with an acceptor ion such as yttrium), and the like.

The electrochemical cell can be embodied in a number of different battery configurations, in which the cells are electrically connected in series, in parallel, or in both series and parallel.

The following non-limiting examples are provided to illustrate certain aspects and features of the methods, electrodes, cells and batteries described herein.

### EXAMPLE 1

### Chemical Synthesis of PbSO₄ Crystals

Lead sulfate crystals were formed by the following procedure:

A 0.8 wt % PEI, 20.3 wt % HOAc solution is prepared by weighing 5.36 g 30% w/v PEI into a 250 mL fluorinated ethylene propylene (FEP) bottle; 156.77 g H₂O is weighed into the bottle; 41.37 g HOAc is weighed into the bottle in a fume hood, and the resulting mixture was shaken well. The pH of this solution was about 2.46. Sulfate and lead solutions were separately prepared as 0.5 M Na₂SO₄ and 0.5 M Pb(NO₃)₂.

To prepare for lead sulfate synthesis, about 0.4 mmol (0.13248 g) of Pb(NO₃)₂ was weighed into a 100 mL round bottom perfluoroalkoxy alkanes (PFA) flask with a stir bar. About 40 mL of the PEPHOAc solution was added and the resulting mixture is stirred at room temperature to dissolve the Pb(NO₃)₂.

The equipment for reacting the precursor solutions, including a programable syringe pump with a LUER LOK-type syringe of a selected syringe diameter was set up, and the pump was programed for a selected injection rate (such as 0.1 or 0.4 mL/min or both), injection volume, or injection time (such as 5.5 to 240 min). The syringes were filled with the appropriate volume of 0.5 M Na₂SO₄ and 0.5 M Pb(NO₃)₂. Finally, the syringe pump program is initiated to prepare the lead sulfate. After finishing injection of lead and sulfate precursors, the reaction mixture was optionally allowed to stir for a selected period of hold time (such as from about 1 minute to about 2 days).

After synthesis, the PbSO₄ crystals were washed as follows: the final reaction volume was split into 50 mL centrifuge tubes with about 22 mL in each tube. Each tube was filled to the 35 mL mark with water, and the resulting mixture was centrifuged at about 8000 rpm for about 5 min. The PbSO₄ crystals were then washed an additional 3 times with water and isolated after each wash by centrifuging at about 8000 rpm for about 5 min. The tubes were then refilled with as much water as desired to disperse the final sample. The crystals can be recovered by filtration and drying, if desired.

### EXAMPLE 2

### Electrochemical Evaluation

The washed PbSO₄ in water suspension was filtered and dried at about 80° C. in vacuum for about 20 min. From the dried PbSO₄, a 30 mg/mL suspension was prepared by adding the appropriate amount of water and sonicating for 15 min. An approximate 1 mg/mL suspension of VXC72 carbon in IPA was prepared by sonicating for about 20-40 min, or until no VXC72 carbon chunks can be observed. An appropriate amount of the 30 mg/mL PbSO₄ suspension was pipetted into the VXC72/IPA suspension to obtain a desired wt % of PbSO₄ and carbon. The PbSO₄ and carbon were sonicated together for about 5 min.

A 3:1 volume ratio of hexane:IPA was added to the centrifuge tube of PbSO₄/C/IPA/H₂O. The carbon/PbSO₄ crashed out of the suspension when the hexane was added. The resulting mixture was centrifuged at about 8000 rpm for about 5 min, and the solvent was poured off carefully. The powders were dried (e.g., at room temperature) and then were ready to prepare inks for electrochemistry evaluation.

5 M H₂SO₄ was prepared by confirming that the density of the 5 M H₂SO₄ was between 1.28-1.285 g/mL. The electrochemical cell was rinsed with H₂O and filled with about 60 mL of 5 M H₂SO₄ . The electrolyte was purged with Ar for about 30 min.

### A. Electrode Preparation

Note: all voltages are versus a Hg/Hg₂SO₄ reference filled with saturated K₂SO₄.

Each glassy carbon (GC) rotating disk electrode RDE) was polished with 0.05 μm Al₂O₃ polishing slurry and rinsed under some H₂O and then put in IPA. The GC RDE were sonicated 15 min in the IPA, rinsed 3-4 times with H₂O, then sonicated 15 min in H₂O. When the electrolyte in the cell was sufficiently purged with Ar, GC conditioning was started. The GC RDE was immersed in the electrolyte at −0.7 V.

The conditioning protocol was CV from −0.6 to −1.8 V, at 200 mV/s, for 10 cycles, at 1000 rpm.

After conditioning, the RDE was dipped in a beaker of water and rotated at about 1000 rpm to rinse for a few seconds.

### B. Electrode Active Material Layer Preparation

A certain amount of a PbSO₄/C sample (about 5-10 mg) was weighed and IPA was added to create an ink with a concentration of 1.85 mg PbSO₄/mL. For example, if the PbSO₄/C composite was 20 wt % carbon, the ink would be 2.31 mg composite/mL. The ink was sonicated 30 min to disperse the composite well. To prepare the active electrode, an RDE was screwed onto an inverted rotator shaft. The RDE was rotated at about 700 rpm while about 5 μL of the ink was dropcast 4 times, with drying in between each droplet. The ink was re-sonicated for about 10 sec before each droplet.

C. Electrochemical Testing Protocol

The GC electrode with active material was immersed into the electrolyte at −0.85 V. The cycling protocol consisted of:
a. Cycling from −0.85 to −1.11 V, at 1 mV/s;
b. Cycling from −1.11 to −1.35 V, at 1 mV/s (calculate charge capacity of this step);
c. Hold at −1.35 V until charge capacity from step b) and the hold step totals the SoC that is required;
d. Cycling from −1.35 to −0.85 V, at 1 mV/s; and
e. Cycling from −0.85 to −1.35 V, at 1 mV/s.

The cycling protocol can of course be varied in many ways to probe effect of SoC, sweep rate, number of cycles, or stop on discharge instead of charge. After testing, the RDE was dipped in a beaker of water and rotated at about 400 rpm to rinse for a few seconds. The RDE was removed from the shaft and dried in air.

### EXAMPLE 3

### Electrodes, Electrochemical Cells, and Batteries

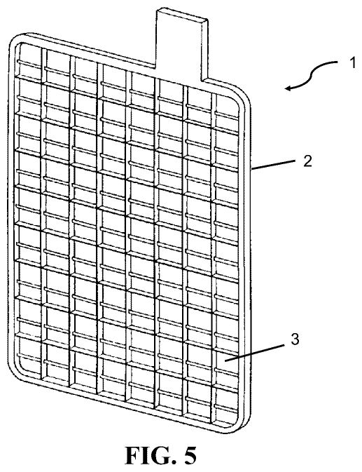

FIG. 5 schematically illustrates a pasted plate type electrode comprising the well-defined PbSO₄ crystals, as described herein. Electrode 1 comprises a grid plate 2 defining chambers 3, with a paste of PbSO₄ crystals and carbon within the chambers.

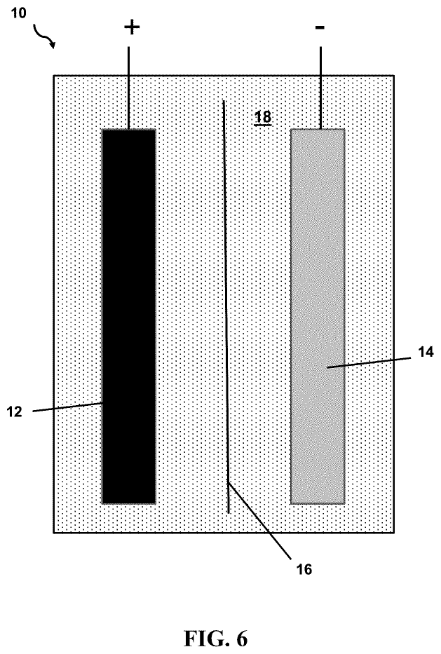

FIG. 6 schematically illustrates a cross-sectional view of a lead-acid electrochemical cell 10 comprising electrode 12 comprising PbSO₄ crystals and carbon in its initial discharged state, and counter electrode 14, with separator 16 therebetween. Sulfuric acid electrolyte 18 contacts electrodes 12 and 14 and separator 16. The electrodes, separator and electrolyte are sealed within housing 19.

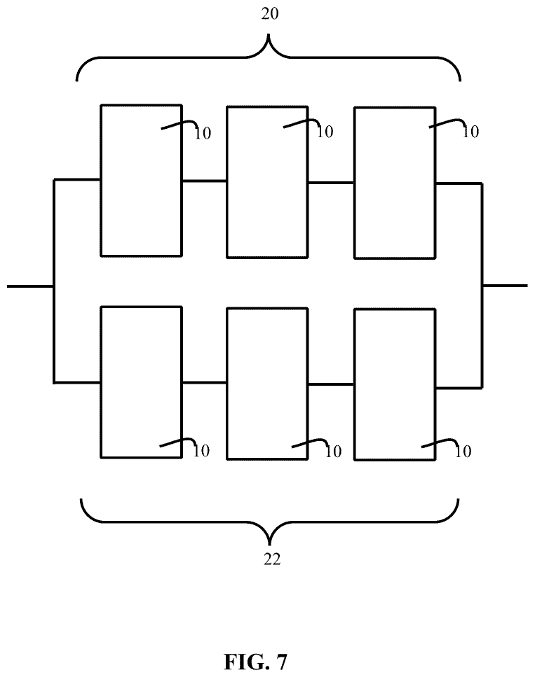

FIG. 7 schematically illustrates a lead-acid battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. An electrode for a lead-acid battery comprising, in an initial, discharged state, a paste of tabular and/or diamond-shaped PbSO₄ crystals in a conductive grid framework; wherein the crystals have a selected average crystal size, as determined by dynamic light scattering and particle imaging using a transmission electron microscope, in the range of about 10 nm to about 2 μm, and at least about 80% of the PbSO₄ crystals in the paste have diameters within about ±20% of the average diameter.

2. The electrode of claim 1, wherein the paste further comprises a particulate carbon material.

3. The electrode of claim 2, wherein the particulate carbon material comprises at least one material selected from the group consisting of carbon black, graphite, free-standing graphene, graphene oxide, reduced graphene oxide, single-walled carbon nanotubes, and multi-walled carbon nanotubes.

4. The electrode of claim 2, wherein the paste further comprises one or more materials selected from the groups consisting of a solid expander additive, baryte group inorganic crystals, polymer fibers, and glass fibers.

5. The electrode of claim 1, wherein the PbSO₄ crystals have an average particle size in the range of about 140 nm to about 160 nm.

6. The electrode of claim 1, wherein the PbSO₄ crystals have an average particle size in the range of about 180 nm to about 220 nm.

7. The electrode of claim 1, wherein the PbSO₄ crystals have an average particle size in the range of about 250 nm to about 290 nm.

8. The electrode of claim 1, wherein the PbSO₄ crystals have an average particle size in the range of about 1 μm to about 1.4 μm.

9. The electrode of claim 1, wherein the conductive grid framework is composed of a hardened lead alloy.

10. A lead-acid electrochemical cell comprising the electrode of claim 1 and a counter electrode with a proton-conductive separator therebetween, wherein the electrode, counter electrode, and separator are immersed in an electrolyte comprising aqueous sulfuric acid.

11. The electrochemical cell of claim 10, wherein the counter electrode comprises at least one material selected from the group consisting of metallic lead, PbO₂, and crystalline PbSO₄.

12. The electrochemical cell of claim 10, wherein the sulfuric acid has a concentration in the range of about 1 to about 5 M.

13. The electrochemical cell of claim 11, wherein the cell has been electrochemically cycled within a voltage window of about 2.5, 2.6 or 2.8V of a negative versus positive electrode to convert at least a portion of the PbSO₄ to Pb(0) at the negative electrode and at least a portion of the PbSO₄ to PbO₂ at the positive electrode, and achieve a state of charge in the range of about 50 to about 100%, thereby forming an active, charged electrode.

14. A lead-acid battery comprising two or more of the electrochemical cell of claim 13 electrically connected in series, in parallel, or in both series and parallel.

15. A lead-acid battery comprising two or more of the electrochemical cell of claim 10 electrically connected in series, in parallel, or in both series and parallel.

16. A method of preparing PbSO₄ crystals with a tabular and/or diamond crystal shape and a selected average crystal size; the method comprising:
mixing equimolar amounts of a Pb(2+)-containing aqueous solution and a SO₄(2−)-containing aqueous solution into an acidic crystal-growth control solution comprising a crystal grrowth modifier and acetic acid at a pH in the range of about 1 to 5, at a defined rate of addition in the range of 0.01 micromoles to 1000 millimoles of Pb(2+) and SO₄(2−) per minute, thereby forming tabular and/or diamond-shaped PbSO₄ crystals that have an average crystal size, as determined by dynamic light scattering and particle imaging using a transmission electron microscope, of about 10 nm to about 2 μm, with a particle size distribution in which at least about 90% of the crystals have a particle size within about 20% of the average diameter;
washing the crystals with water to remove and the crystal-growth modifier and soluble salt contaminants; and
recovering the crystals.

17. The method of claim 16, wherein the crystal-growth modifier is present in the crystal-growth control solution at a concentration in the range of 0.01 to 50 g/L, and the volume of the crystal-growth control solution is about 0.1 to about 10 times the total volume of the Pb(2+) and SO₄(2−) solutions being added.

18. The method of claim 16, wherein the Pb(2+)-containing precursor solution and the SO₄(2−)-containing precursor solution have concentrations in the range of about 0.001 to about 1M.

19. The method of claim 16, wherein the crystals are allowed to grow for a selected period of time in the range of about 0.1 to about 5000 minutes, before the crystals are isolated and washed with water to remove the crystal-growth modifier and soluble salt contaminants.

20. The method of claim 16, wherein the crystal-growth modifier is selected from the group consisting of a linear or branched polyimine, a linear or branched polymer comprising charged quaternary amino groups, a linear or branched non-polymeric amine, and a water soluble polymer.

21. The method of claim 16, wherein the crystal-growth modifier comprises poly(ethyleneimine).

22. Crystalline PbSO₄ comprising tabular and/or diamond-shaped crystals having an average crystal size, as determined by dynamic light scattering and particle imaging using a transmission electron microscope, of about 50 nm to about 2 μm, with a particle size distribution in which at least about 90% of the crystals have a particle size within about 20% of the average diameter.

23. The crystalline PbSO₄ of claim 22, wherein the crystals have an average diameter selected from the group consisting of (a) about 140 nm to about 160 nm; (b) about 180 nm to about 220 nm; (c) about 250 nm to about 290 nm; and (d) about 1 μm to about 1.4 μm.
